(19) United States
(12) Patent Application Publication
(10) Pub. No.: US 2014/0072744 A1
(43) Pub. Date: Mar. 13, 2014

(54) Tube Weight

(71) Applicant: Mark Sitcoske, Providence, RI (US)

(72) Inventor: Mark Sitcoske, Providence, RI (US)

(21) Appl. No.: 13/607,953

(22) Filed: Sep. 10, 2012

(51) Int. Cl. B32B 1/08

(52) U.S. Cl. CPC B32B 1/08
USPC 428/36.9

(57) ABSTRACT

The present invention specifies a tube weight that is characterized as a tube weight used to maintain the position of a dip tube in an optimal location within a container while allowing liquid to flow through; made out of polyvinylidene difluoride; and while being highly non-reactive as is required in the bio-processing field.

### CROSS REFERENCES TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

This invention relates, in general, to the field of tube weights, and, more specifically, to tube weights which are used to increase productivity and effectiveness of pumps in the field of bio-processing.

Within the bio-processing field, dip tubes are connected to pumps and then inserted to containers filled with a liquid. It is needed to keep the dip tube at an optimal location, generally the bottom of the container. There is a barb on the stem of the tube weight that secures the dip tube to the tube weight. The liquid passes through the channels on the bottom of the tube weight; into the flow-through tunnel, a hollow center of the tube weight; and then into the dip tube. The tube weight keeps the dip tube from floating to the top, or attaching by a vacuum to the side, of the container. In that occurrence, the pump attached to the dip tube ceases to function correctly and fails.

Presently tube weights are made out of various metals that can be reactive with the various substances used in the bio-processing field. The bio-processing field is a field that relies on high purity; therefore, there is a need for a tube weight made out of a non-reactive material. Polyvinylidene difluoride is a highly non-reactive and pure thermoplastic fluoropolymer produced by the polymerization of vinylidene difluoride. Polyvinylidene difluoride is used in applications requiring the highest purity, strength, and resistance to solvents, acids, bases and heat.

### SUMMARY OF THE INVENTION

The present invention is a tube weight constructed of polyvinylidene difluoride that is used to maintain the position of a dip tube in an optimal location within the container while allowing liquid to flow through while being highly non-reactive.

### DESCRIPTION OF DRAWINGS

FIG. 1 is a side view of a tube weight of the present invention

FIG. 2 is a bottom view of a tube weight in FIG. 1

FIG. 3 is a table giving the dimensions in inches (in) of the lengths designated “A”, “B”, “C”, “D”, “E”, “F”, “H”. “I”, and “J” in FIG. 1

FIG. 4 is a table giving the dimensions in inches (in) of the lengths designated “A”, “B”, and “C” in FIG. 2

### DETAILED DESCRIPTION OF THE INVENTION

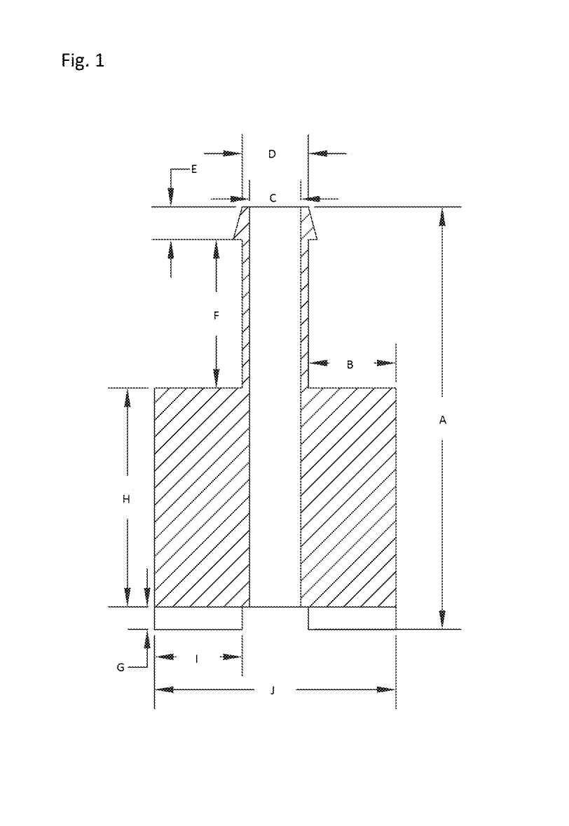

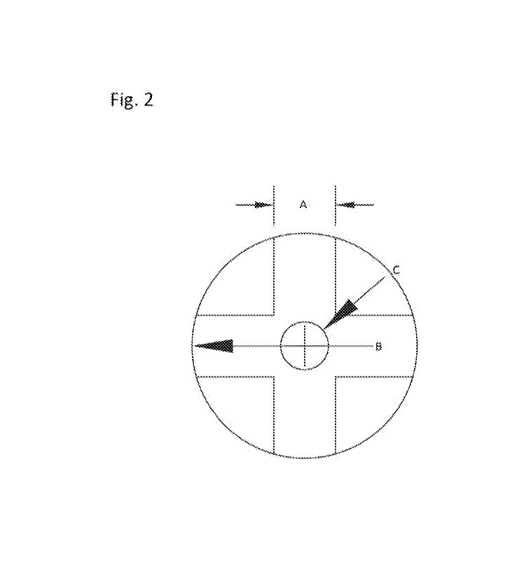

Referring now to the invention in more detail, in FIG. 1 and FIG. 2 there shown is a tube weight.

In further detail, still referring to the invention of FIG. 1 and FIG. 2, the tube weight is of adequate weight to maintain the optimal positioning of the dip tube which is 0.0440 pounds. The length A of FIG. 1 of the tube weight is 1.7500 inches with a diameter B of FIG. 2 of 1.0000 inches. The hollow center C of FIG. 2 is 0.2125 inches; allowing the channels A of FIG. 2 to be 0.2740 inches. The stem F of FIG. 1 is 0.6145 inches and the space B of FIG. 1 from the stem to the edge of the tube weight is 0.3630 inches. The stem measures 0.2740 inches across the top D of FIG. 1 with a lip E of FIG. 1 measuring 0.1355 inches. The main body of the tube weight H of FIG. 1 is 0.9065 inches. The channels I of FIG. 1 are 0.3630 inches from the perimeter of the tube weight to the hollow center and am 0.0935 inches in depth G of FIG. 1.

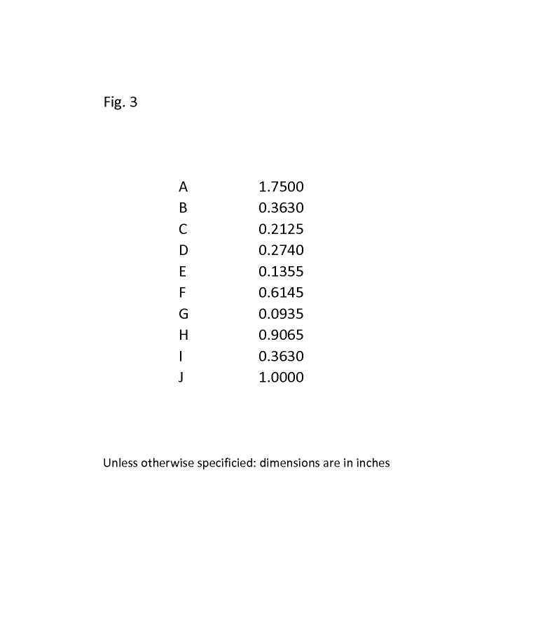

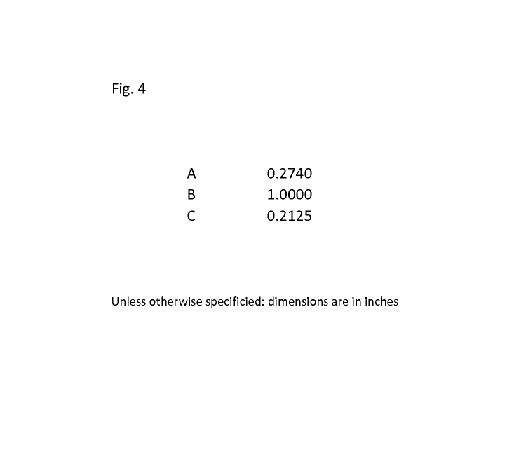

The construction details of the invention as shown in FIG. 1 and FIG. 2 are that the tube weight is made from a solid piece of polyvinylidene difluoride with a diameter of 1.0000 inches which is then cut into 1.7500 inch sections. These are subsequently lathed to the correct dimensions, as listed on FIG. 3 and FIG. 4. The hollow center is drilled out to the measurements listed on FIG. 4.

The advantages of the present invention include, without limitation, that it is highly non-reactive while still allowing for optimal positioning of the dip tube and peak flow of the liquid.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A tube weight, comprising:
a polyvinylidene difluoride object where the user secures it to a dip tube;
a stem on the top of the polyvinylidene difluoride object as a liquid flow-through tunnel; and
a channel on the base of the polyvinylidene difluoride object for where the liquid has access to the flow-through tunnel.
